(19) United States
(12) Patent Application Publication
(10) Pub. No.: US 2003/0196308 A1
(43) Pub. Date: Oct. 23, 2003

(54) Grind rail and transport kit

(76) Inventor: Harris Daniel Kelsey, Hollister, CA (US)

Correspondence Address: William J. Kolegraff, 3119 Turnberry Way, Jamul, CA, 91935, US

(21) Appl. No.: 10/125,817

(22) Filed: Apr. 18, 2002

(51) Int. Cl. B23P 19/00

(52) U.S. Cl. 29/426.3

(57) ABSTRACT

A grind rail and transport kit provides a conveniently portable and durable grind rail. In use, the grind rail has stands that support a grind beam, thereby providing a stable riding surface. The assembled grind rail is of sufficient height, length, and stability to provide a safe and stable riding experience. To facilitate portability, the grind rail disassembles into rail pieces and stand pieces. The rail pieces and stand pieces cooperate to form a stable transportable assembly. The transportable assembly is about one-half the length of the grind rail, and is about as wide as the grind beam.

### BACKGROUND

The field of the present invention is mechanical sporting equipment. More particularly, the present invention relates to grind rails for sporting activities such as skateboarding, BMX biking, and skating.

Skateboarding is a popular sporting activity. In a particularly desirable aspect of skateboarding, skateboarders perform tricks, stunts, or other maneuvers to increase the excitement and complexity of the sport. Other sports, such as BMX biking, skating, and riding scooters also may perform such activities. In performing these various maneuvers, skateboarders often use accessory devices such as grind rails, half-pipes, and various types of jumps and ramps. Unfortunately, the sport of skateboarding has suffered from a lack of convenient and accessible skate parks, where permanent installations of such accessories may be used. Accordingly, skateboarders often have been forced to use makeshift accessories. For example, skateboarders may use a handrail adjacent a public sidewalk as a substitute for a grind rail, or may place boards against a curb to substitute for a ramp. Such makeshift use not only may be dangerous to the skateboarder, but also may interfere with the intended use of sidewalks and streets.

In an effort to respectfully use public space, skateboarders prefer to use portable accessory equipment that is specifically designed for skateboard tricks. For example, co-pending U.S. patent application Ser. No. ______, filed Mar. 18, 2002, and entitled “Launch Ramp and Method of Making Same”, discloses a portable launch ramp for sport use. Such a launch ramp enables a rider to propel themselves into the air to perform tricks or other stunts. Skateboarders and other riders also use a grind rail to perform tricks or other stunts.

Generally, a grind rail is an elevated and elongated bar that is stable enough to support a rider. The rider generally approaches the grind rail at a high rate of speed, and then jumps or otherwise maneuvers his or her skateboard onto the grind rail. The rider then “grinds” the skateboard along the rail, balancing or performing tricks. At the completion of the ride, the rider drops or pushes off the grind rail.

For permanent installations, grind rails may look like hand rails, and may be several feet off the ground and about eight to fifteen feet long. However, lower elevations, such as one foot, may still provide an enjoyable ride experience, and may be more safely maintained in a portable grind rail. Also, grind rails less than eight feet may still provide an enjoyable experience, but shorter rails tend to be less fun.

Portable grind rails are known which skateboarders may set in a safe public area and utilize without interfering with pedestrians or cars. However, known portable grind rails generally fall into one of two undesirable categories. First, some known grind rails are either too heavy or bulky to be easily transported. These rails tend to be long enough and high enough to be fun, but are very sturdy and heavy for safety and to provide a stable ride effect. It may be difficult to transport these grind rails, so their use is quite limited. For example, a solid steel grind rail provides safety and stability, but is too heavy for easy transport. In another example, an eight foot grind rail may provide a fun ride, but it is not possible to easily stowed in the trunk of a car. Further, it is difficult for a retailer to stock and display such bulky and unwieldy items.

In the second undesirable category, grind rails are light and easily transported. Unfortunately, these grind rails tend to be either too short or too low to be fun. Or worse, they lack the necessary structure and mass to provide a safe and stable ride. Although these may be appropriate for some young children or novice riders, more experience riders will be disappointed with the ride, or endangered by the flimsy construction.

Accordingly, there is a need for an easily transported grind rail that provides a safe, stable, and fun ride experience.

### SUMMARY

It is therefore an object of the present invention to overcome the deficiencies of known portable grind rails. It is a further object of the present invention to provide a conveniently portable and durable grind rail having superior riding characteristics.

Briefly, the present invention provides a conveniently portable and durable grind rail. In use, the grind rail has stands that support a grind beam, thereby providing a stable riding surface. The assembled grind rail is of sufficient height, length, and stability to provide a safe and stable riding experience. To facilitate portability, the grind rail disassembles into rail pieces and stand pieces. The rail pieces and stand pieces cooperate to form a stable transportable assembly. The transportable assembly is about one-half the length of the grind rail, and is about as wide as the grind beam.

In a preferred example of the grind rail, the rail pieces detachably coupled to form the transport assembly. When coupled, the rail pieces generally form a frame, which is substantially in a rectangular shape. The rail pieces are also constructed to hold the stands within the frame. When secured, the frame may be easily transported. Also, the rail pieces may be constructed to hold other pieces to the grind rail, such as a connector piece.

Advantageously, the disclosed portable grind rail provides an extremely durable and stable construction. However, even with such superior durability and stability, the grind rail maintains a size, shape, and weight for convenient portability. For example, the grind rail can be about eight feet long and over one foot high when in use, but breaks down to a size and a form-factor that is easily transportable. Importantly, the grind rail also provides a high quality, enjoyable, and safe ride experience. These and other advantages will become apparent by review of the figures and detail descriptions that follow.

### BRIEF DESCRIPTION OF THE DRAWINGS

FIGS. 1a, 1b, and 1c show plan, top, and side views, respectively, of a transport assembly for a grind rail in accordance with the present invention;

FIG. 2 shows a transport kit for a grind rail in accordance with the present invention;

FIG. 3 shows a transport kit for a grind rail in accordance with the present invention;

FIG. 4 is a plan view of a portable grind rail in accordance with the present invention; and

FIGS. 5a, 5b, and 5c show plan, side, and top views of a portable grind rail in accordance with the present invention; and

FIG. 6 shows another transport assembly and grind rail kit in accordance with the present invention.

### DETAILED DESCRIPTION

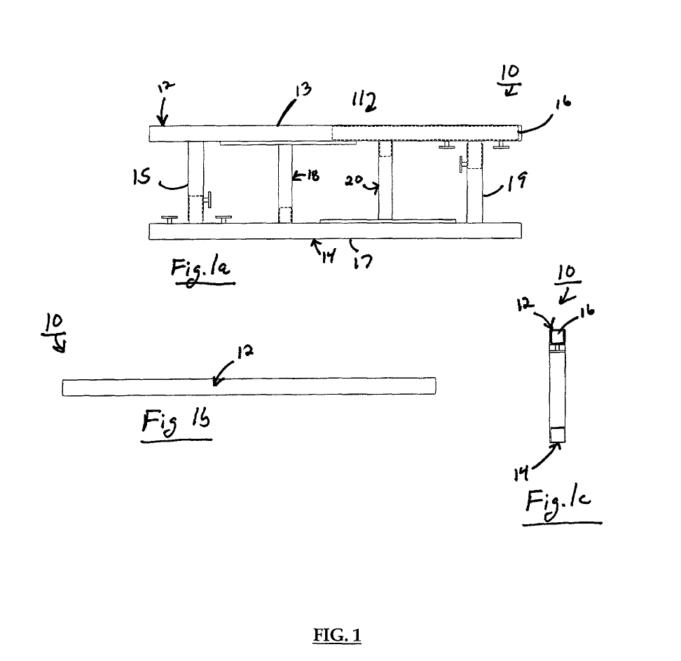

Referring now to FIG. 1A, an example of a transport assembly for a grind rail is illustrated. The transport assembly 10 provides an easy to transport kit of the pieces necessary to construct a grind rail. Transport assembly 10 generally comprises rail piece 12 and rail piece 14 coupled to form a frame 11. Frame 11, which is generally rectangular in shape, has side 13, side 15, side 17, and side 19. Stand 18 and stand 20 are positioned within the frame 11. The frame 11 provides for a transport assembly that is flat and easy to lift, carry, put in a vehicle, or otherwise transport.

When assembled for use, stands 18 and 20 cooperate with rail pieces 12 and 14 respectively to construct a grind rail. A connecter 16 provides additional support and strength for the assembled grind rail. However, when assembled as a transport assembly, connecter 16 is contained within one of the rail pieces, such as rail piece 12. Accordingly, the transport assembly has all the components required to assemble a fun and stable grind rail.

In a preferred example of transport assembly 10, transport assembly 10 has an overall length of approximately 4 feet. As illustrated in FIG. 1B, the transport assembly 10 has an overall width equal to the width of the rail piece. More specifically, the stand 18 and 20 are substantially contained within the width of the rail piece. Such an arrangement allows for convenient and flat transport, and presents a manageable form factor. In a preferred embodiment of the transport assembly 10, the overall width is approximately 2 inches wide.

Referring now to FIG. 1C, it is illustrated that the transport assembly 10 has a height approximately equal to the height of rail piece 12, plus rail piece 14, plus the stand height. In a preferred embodiment of transport assembly 10, the overall height of the transport assembly is approximately 14 inches.

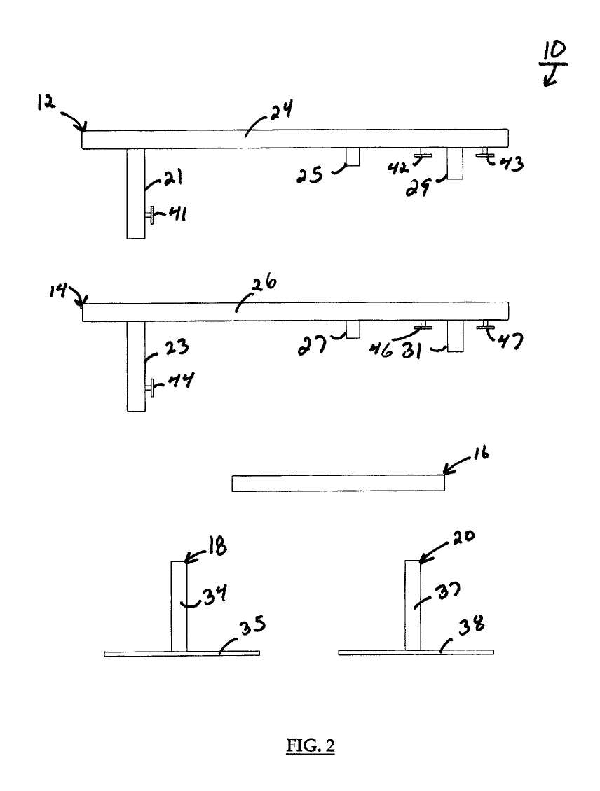

Referring now to FIG. 2, the individual components of transport assembly 10 are identified in more detail. Rail piece 12 comprises a grind beam piece 24. Grind beam piece 24 may be, for example, constructed from rectangular aluminum tubing or piping. In a preferred construction, grind beam 24 is constructed of 2-inch diameter rectangular aluminum pipe. It will be appreciated, however, that other diameters and materials may be substituted consistent with this disclosure. A riser 21 is permanently attached to grind beam piece 24. Preferable, riser 21 is constructed of the same material as grind beam piece 24. Riser 21 may be attached to grind beam piece 24, for example, by welding. Although welding is a preferred attachment method, it will be appreciated that other methods may be used, such as a threading attachment means.

Tensioner 41 is a attached to riser 21 for securing a stand into the riser 21. The tensioner may be, for example, a nut welded on to riser 21 with a wing-nut bolt used to compress a member placed inside the riser 21. It will also be appreciated that the tensioner 41 may be formed by having a thin wall threading process place threads in the wall of riser 21, and using a wing nut bolt to again provide a compressive force. Alternatively, legs 34 and 37 may have threaded holes formed by a thin wall threading process, with the threaded holes aligning with punched holes in the risers 21 and 23, respectively. In a similar fashion, tensioners 42 and 43 are attached to grind beam piece 24. Tensioners 42 and 43 will be described later when assembling the transport assembly 10 into a grind rail.

Rail piece 12 also includes a riser nub 29. Riser nub 29 is preferably of the same material as riser 21, but of a smaller diameter. For example, if riser 21 is a 2-inch rectangular pipe, then riser nub 29 may be provided as a 1-¾ inch rectangular pipe. Rail piece 12 also includes a stand nub 25. Stand nub 25 preferably is made of the same material of as grind beam piece 24, but has a diameter smaller than riser nub 29. For example, if riser nub 29 is 1-¾ inch rectangular pipe, then stand nub 25 may be 1-½ inch rectangular pipe. In a preferred embodiment, grind beam piece 24, riser 21, riser nub 29, and stand nub 25 are all rectangular aluminum pipe. However, grind beam piece 24 and riser 21 are 2 inches in diameter, riser nub is a 1-¾ inches in diameter, and stand nub 25 is 1-½ inches in diameter. It will be appreciated that the diameter dimensions may be adjusted consistent with the teachings of this application.

In one example of transport assembly 10, rail piece 14 is identical to rail piece 12. More particularly, grind beam piece 24 is like grind beam piece 26, riser 23 is like riser 21, riser nub 31 is like riser nub 29, and stand nub 27 is like stand nub 25. Further, tensioners 44, 46, and 47 are like tensioners 41, 42, and 43 respectively. In an alternate configuration, rail piece 14 may be provided without riser nub 31. Such a construction eliminates the additional step of adding riser nub 31, and also may facilitate easier assembly and disassembly. Assembly of a grind rail will be described in detail in a section below.

Transport assembly 10 also includes a connecter piece 16. Connecter piece 16 is constructed to fit inside grind beam piece 24 and grind beam piece 26. Preferably, connecter piece 16 is constructed of the same material as grind beam pieces 24 and 26, however connecter piece 16 is of a slightly smaller diameter. For example, if grind beam piece 24 and grind beam piece 26 are a 2 inch diameter rectangular aluminum pipe, then connecter piece 16 could be a 1¾ inch diameter rectangular aluminum pipe.

Transport assembly 10 also contains 2 stands. Stand 18 comprises a leg 34 permanently attached to foot 35. Leg 34 is constructed to be received into riser 21. Preferably, leg 34 is constructed of the same material as riser 21, however at a slightly narrower diameter. For example, if riser 21 is a 2-inch diameter rectangular aluminum pipe, then leg 34 could be a 1-¾ inch rectangular aluminum pipe. Foot 35 is also preferably constructed of the same material as leg 34. In this regard leg 34 may be welded or otherwise attached to foot 35. In a preferred embodiment foot 35 is a half-inch aluminum bar approximately 2 inches wide and 18 inches long. It will be appreciated that other thickness, widths, and lengths may be used depending upon the stability needed for the assembled grind rail. For example, a longer foot 35 may be useful for higher elevations or to support a longer rail. In a preferred embodiment, leg 34 rises approximately 10 inches above foot 35. Stand 20 is identical to stand 18. More specifically, leg 37 is like leg 35, and foot 38 is like foot 35.

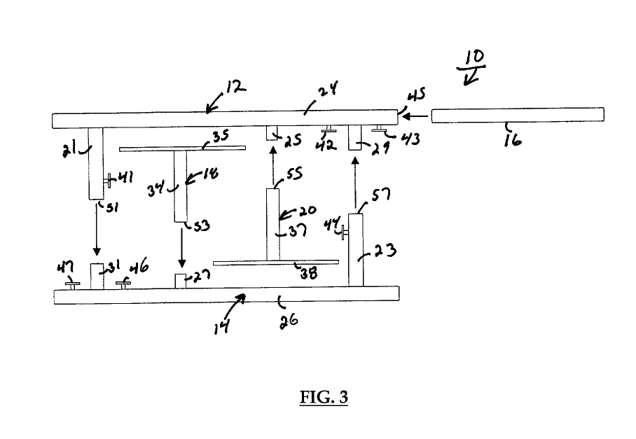

Referring now to FIG. 3, assembly instructions are identified for transport assembly 10. Rail piece 12 has riser 21 with an opening 51. Opening 51 is sized to slidably receive riser nub 31. In a similar manner rail piece 14 has riser 23 having an opening 57. Opening 57 is sized to slidably receive riser nub 29. As briefly described earlier, it is possible to eliminate riser nub 31 from rail piece 14. Removing riser nib 31 simplifies construction of rail piece 14, and also may facilitate easier assembly of the transport assembly 10.

Stand 18 has leg 34 having an opening 53. Opening 53 is sized to slidably receive stand nub 27. In a similar manner stand 20 has leg 37 with opening 55. Opening 55 is sized to slidably receive stand nub 25. As can be seen in FIG. 3, foot 35 and foot 38 are positioned to be substantially parallel with grind beam piece 24 and grind beam piece 26, respectively. In this regard, foot 35 and foot 38 do not extend beyond the width of the grind beam pieces. However, it will be appreciated that foot 35 and foot 38 may extend slightly if a wider foot is needed for additional stability.

In the process of assembling the transport assembly 10, rail piece 12 is brought toward rail piece 14, causing riser nub 31 to be received into opening 51 and riser nub 29 to be received into opening 57. In this regard, grind beam piece 24, riser 21, grind bean piece 26, and riser 23 cooperate to generally form a rectangular shaped frame. As rail piece 12 is further brought closer to rail piece 14, stand nub 27 is received into leg opening 53 and stand nub 25 is received into leg opening 55, thus positioning the stands 18 and 20 within the rectangular frame.

When rail piece 12 and rail piece 14 are fully engaged, the bottom of foot 35 will be in contact with grind beam piece 24 and the bottom of foot 38 will be in contact with grind beam piece 26. Tensioner 44 and tensioner 41 may then be tightened to secure rail piece 12 to rail piece 14. As previously described, if riser nub 31, is not present, tensioner 44 is sufficient to secure rail piece 12 to rail piece 14. When secured, the transport assembly may be readily lifted, moved, or otherwise transported.

Connector 16 may also be secured in the transport assembly 10. In this regard, opening 45 is sized to slidably receive connecter 16. Therefore, connecter 16 may be slid completely into grind beam piece 24, and secured with tensioners 42 and 43. Alternatively, connecter 16 could be inserted into grind beam piece 26 and secured with tensioners 46 and 47. With connector 16 secured into the transport assembly 10, the transport assembly contains all pieces necessary to assemble a grind rail, as will be described below. For reference, FIG. 1 shows an assembled and secured transport assembly 10.

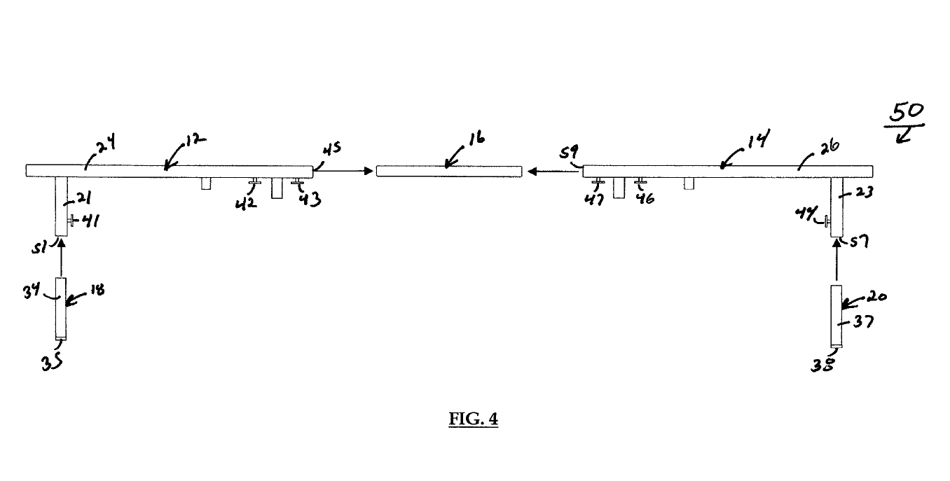

Referring now to FIG. 4, a grind rail assembly 50 is illustrated. Grind rail assembly 50 is constructed from the pieces comprising the transport assembly 10 describe above. In this regard, it will be seen that a fully functioning grind rail may be constructed from transport assembly 10. Grind rail assembly 50 is assembled by connecting rail piece 12 to rail piece 14 using connecter 16. More specifically grind beam piece 24 has opening 45 sized to slidably receive an end portion of connector 16, while grind beam piece 26 has opening 59 sized to receive the other end portion of connecter 16. It is preferable that one-half the length of connecter 16 be inserted into grind beam piece 24 and the other one-half of connecter 16 be inserted into grind rail piece 26. Such an assembly will give maximum stability and strength. However, it will be appreciated that other constructions may be sufficient.

In one embodiment of grind rail assembly 50, grind beam piece 24 and grind beam piece 26 are each 4 feet in length. For stability and strength, connecter piece 16 is then sized at a length of 2 feet, although it will be appreciated that other lengths may be used for specific applications. For example, a longer piece may be useful to provide additional strength for advanced riders. When rail piece 12 has been brought toward rail piece 14 such that grinder rail piece 24 is contacting grinder rail piece 26, then tensioners 42,42,47, and 46 will be tensioned against connecter 16. When fully engaged, these 4 tensioners securely hold connecter 16 inside the rail pieces 12 and 14, creating a single elongated riding surface. As described earlier in regard to tensions 41 and 44, these tensioners may be constructed of nuts welded to the rail pieces, or may have threads integrally formed in the sidewalls of the rail pieces 26 and 26, which align with holes in the connector. Alternatively, threads may be formed in the sidewalls of the connector, with the threaded holes aligned with holes punched in the rail pieces. In this regard, a bolt, such as a wing nut bolt, would extend through the rail piece and engage the thread in the connector 16. When tightened, the connector and rail pieces would be securely attached, but yet allow for easy disassembly.

The stands 18 and 20 are rotated so that feet 35 and 38 are positioned perpendicular to the rail pieces 12 and 14. Riser 21 has opening 51 which has been sized to slidably receive leg 34, while riser 23 has opening 57 which has been sized to receive leg 37. The legs are inserted into the risers, and tensioners 41 and 44, respectively, are used to secure the stands to the rail pieces. The legs 34 and 37 may be completely inserted into the risers 21 and 23, or may be partially inserted for additional elevation. In a preferred configuration of grind rail assembly 50, the legs 34 and 37 are approximately 10 inches in length. Accordingly, when the legs are fully inserted into the risers, the top of the rail pieces will be over one foot above the ground or other support surface.

Depending on the specific location of the tensioners 41 and 44, the legs may extend from the risers, enabling the stands to be raised. In one embodiment, the legs may be extended approximately 6 inches. In this configuration, the rail pieces would be elevated over 18 inches above the supporting surface. Tensioners 44 and 41 may be wing nut bolds acting through threads to compress against legs 34 and 37 respectively. However, it will be appreciated that other tensioning methods may be used. For example, tensioners 41 and 44 maybe pass-through bolts that cooperate with holes in the legs. In one construction, the legs could be provided with holes at one-inch intervals. In this regard the bolt could enable the stand leg to be extended in one-inch increments. Such a construction would facilitate easy leveling of the rail surface.

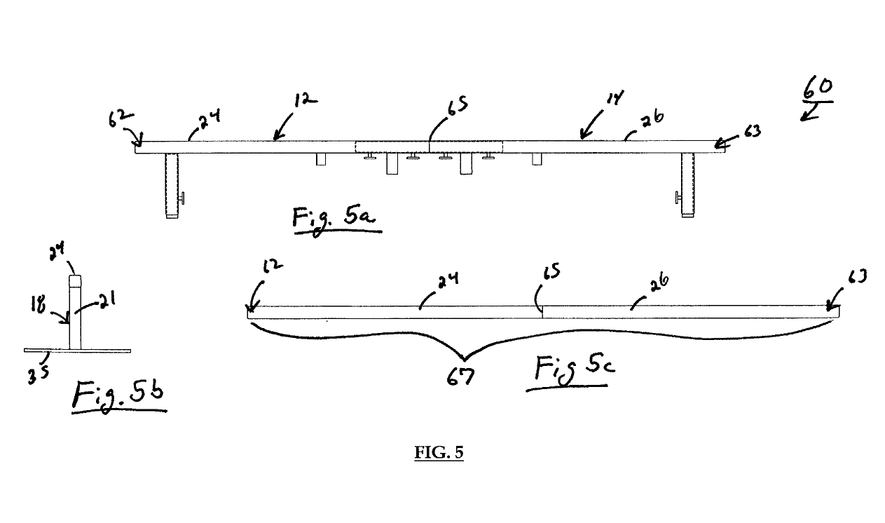

Referring now to FIGS. 5A, 5B, and 5C, grind rail 60 is illustrated. Grind rail 60 is constructed of the same components as transport assembly 10 and grind rail assembly 50. When grind beam piece 24 and grind beam piece 26 are pushed together to meet at mating surface 65, an elongated riding surface 67 is formed. In a prefer example, riding surface 67 may be 8 feet long. It will be appreciated other riding surfaces lengths may be accomplished by adjusting other dimensions.

It will also be appreciated that various modifications may be made to the grind rail and transport assembly consistent with this disclosure. For example, rail ends 62 and 63 could be rounded to facilitate easier entering and exiting of the riding surface 67. Different materials and compositions may be utilized in construction of the various pieces. Additionally, other construction and attachment methods may be used. For example, the connecter piece 16 could be constructed integrally with one of the rail pieces. Such a construction would require certain modifications in dimensions and positioning but would eliminate a discreet component of the transport assembly. In another example of an alternate construction, the rail pieces would not need to be symmetrical. Such a configuration could allow for particular weight balancing, or allow for more than 2 stands. Further, it is contemplated that particular grind rails may be constructed with more than 2 rail pieces.

In making the transport assembly 10, rectangular aluminum tubing stock of the appropriate diameter is cut to specific lengths as indicated previously. The pieces are cleaned and deburred to reduce risk of cut and abrasions. A thin wall threading process may be used to place threads for the tensioners. Alternatively, tensioners may be formed by drilling a hole and welding nuts to receive a wing-nut tensioner bolt.

Tubing stock that are to be permanently attached are welded together using a standard welding process. The pieces are cleaned, primed, and painted. Alternatively, the pieces are powder coated for additional aesthetic appeal and durability. Finally, the pieces are assembled into their transport assembly configuration, and tensioners positioned and secured. The pieces, now in the form of a transport assembly, are boxed and ready for shipment.

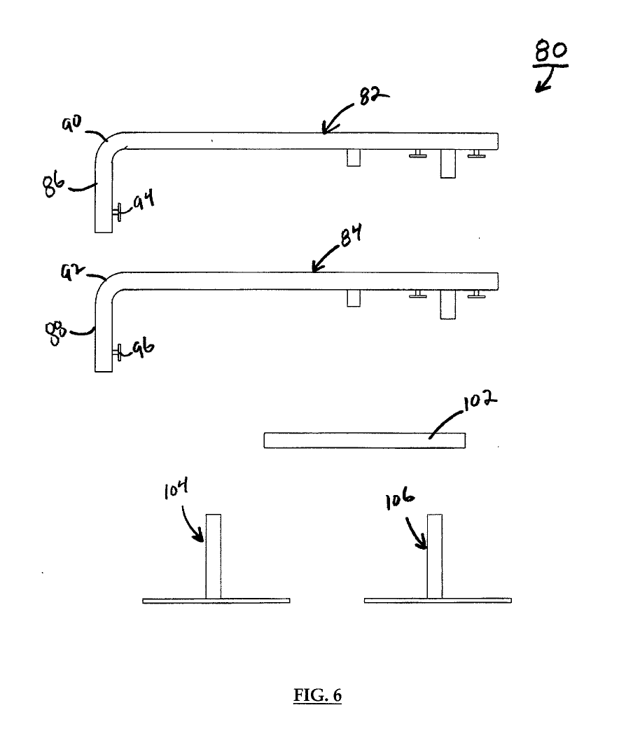

Referring now to FIG. 6, another transport assembly and grind rail 80 is illustrated. Transport assembly and grind rail 80 is similar to assembly 10 previously described. However, assembly 80 is constructed with each riser integrally formed with its associated rail piece. More particularly, forming a bend 90 in an aluminum tube integrally forms riser 86 and rail piece 82. In a similar manner, forming a bend 92 in another aluminum tube integrally forms riser 88 and rail piece 84.

As previously described, tensioners, such as tensioners 94 and 96, are used to removeably couple stand 104 to riser 86 and stand 106 to riser 88, respectively. Connecter piece 102 is like connector piece 16 previously described. Also, stands 104 and 106 are similar to stands 18 and 20, previously described, but may have a different leg height to accommodate bends 90 and 92, respectively. By bending the aluminum tube to integrally form the riser and rail piece, assembly 80 has rail pieces that are easy to manufacture, and the bended ends provide a safe and smooth transition for riders.

Advantageously, a stable, fun, and full size grind rail may be stored or transported in a flat, convenient transport assembly. For example, a full eight-foot grind rail capable of use at an elevation of over 18 inches may be transported in a transport assembly having dimensions of only about 4 feet by 14 inches by 2 inches. Such a convenient transport configuration facilitates ease of transport by the rider, and also enables a distributor or others in the sales channel to conveniently stock and display grind rails. For example, a four-foot stack of packaged grind rails may contain about 20 grind rails. Such density of storage enables distributors and sellers to maintain a substantial stock without dedicating scare storage space.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

What is claimed is:

1. A transport assembly for constructing a grind rail, comprising:
a first rail piece having a first riser for accepting a first stand;
a second rail piece having a second riser for accepting a second stand; and
a nub on the first rail piece cooperating with the second riser to detachably couple the first rail piece to the second rail piece.

2. The transport assembly according to claim 1 wherein the first rail piece and the first riser are integrally formed with a bend therebetween, and the second rail piece and the second riser are also integrally formed with a bend therebetween.

3. The transport assembly according to claim 1 wherein the first rail piece and the first riser are discrete pieces welded together, and the second rail piece and the second riser are also discrete pieces welded together.

4. The transport assembly according to claim 1 wherein the first rail piece further includes a stand nub, the stand nub constructed to cooperate with the first stand to position the first stand between the first riser and the second riser.

5. The transport assembly according to claim 1 wherein the second rail piece further includes a stand nub, the stand nub constructed to cooperate with the second stand to position the second stand between the first riser and the second riser.

6. The transport assembly according to claim 1 further including a connector piece to couple the first rail piece to the second rail piece, the first rail piece constructed to releasably contain the connector piece.

7. The transport assembly according to claim 1 wherein the second riser is a pipe, and nub is constructed to be received inside the second riser pipe.

8. The transport assembly according to claim 1 wherein a tensioner is used to detachably couple the first rail piece to the second rail piece.

9. The transport assembly according to claim 8 wherein the tensioner is constructed in the form of a nub-thread that receives a bolt, the bolt used to tension the nub and second riser.

10. The transport assembly according to claim 1 further including another nub on the second rail piece cooperating with the first riser to detachably couple the first rail piece to the second rail piece.

11. The transport assembly according to claim 1 wherein the first rail piece is about half the length of the grind rail.

12. The transport assembly according to claim 1 wherein the second rail piece is about half the length of the grind rail.

13. A method of preparing a grind rail for transport, the grind rail having a grind beam and stands, comprising:
disassembling the grind rail into a first rail piece and a second rail piece;
arranging the first rail piece and the second rail piece into a transport assembly, the transport assembly being about half the length of the grind beam;
arranging the stands in the transport assembly, the transport assembly being about the width of the grind beam; and
coupling the first rail piece to the second rail piece to secure the transport assembly.

14. The method according to claim 13, wherein the grind rail includes a connector piece to connect the first rail piece to the second rail piece, and the method includes securing the connector piece in the transport assembly.

15. A grind rail kit, comprising:
a first stand and a second stand;
a first rail piece having a riser for receiving the first stand;
a second rail piece having a riser for receiving the second stand;
at least one of the rail pieces having a riser-receiving member configured to detachably couple the first rail piece to the second rail piece; and
at least one of the rail pieces having a stand-receiving member configured to retain at least one of the stands.

16. The grind rail kit according to claim 15, wherein at least one of the rail pieces has stand-receiving members configured to retain both of the stands.

17. The grind rail kit according to claim 15, wherein the other rail piece has another stand-receiving member configured to retain the other stand.

18. The grind rail kit according to claim 15, wherein the grind rail includes a connector piece, and at least one of the rail pieces is configured to detachably retain the connector piece.

19. A grind rail assembly, including:
a first rail piece and a second rail piece;
a first stand and a second stand;
a connector piece for coupling the first rail piece to the second rail piece;
wherein the grind rail is constructed to be disassembled and secured into a transport kit, the transport kit having a length of about one-half the length of the grind rail.

20. The grind rail according to claim 19, wherein the grind rail has a length of about eight feet, and the transport kit has a length of about four feet.

21. The grind rail according to claim 19, wherein the transport kit has a width about the same as the width of one of the rail pieces.

22. The grind rail according to claim 19, wherein the grind rail has a length of about eight feet, and the transport kit has a length of about four feet.

23. The grind rail according to claim 19, wherein the transport kit has a height of about the sum of the height of the grind rail plus the height of one of the rail pieces.

24. The grind rail according to claim 19, wherein the grind rail has a height of about twelve inches, and the transport kit has a height of about fourteen inches.

25. A grind rail transport assembly, including:
a first rail piece and a second rail piece;
a first stand and a second stand;
a frame formed by detachably coupling the first rail piece to the second rail piece; and
wherein the stands fit within the perimeter of the frame.

26. The grind rail transport assembly according to claim 25, further comprising a connector piece for coupling the first rail piece to the second rail piece, and wherein the connector fits within the perimeter of the frame.
